(19) United States
(12) Patent Application Publication
(10) Pub. No.: US 2007/0200952 A1
(43) Pub. Date: Aug. 30, 2007

(54) Television receiver

(75) Inventor: Junya Senoo, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funia Electric Co., Ltd., Daito-shi (JP)

(21) Appl. No.: 11/708,070

(22) Filed: Feb. 20, 2007

(30) Foreign Application Priority Data
Feb. 17, 2006 (JP) 2006-41505

(51) Int. Cl. H04N 7/10; H04N 5/44

(52) U.S. Cl. 348/553; 725/32

(57) ABSTRACT

A television receiver comprising: a memory that stores messages including messages input through a remote control and messages received via a network interface; and a microcontroller that determines whether or not there is a message recorded in the memory. When a user presses a power button to power off the television receiver, the microcontroller determines whether or not a message that has yet to be displayed is recorded in the memory. When it is determined that there is a yet-to-be-displayed message recorded in the memory, the microcontroller displays the message on a display. Subsequently, when a user presses an acknowledge button, the microcontroller deletes the message displayed on the display from the memory.

### BACKGROUND OF THE INVENTION

1. Field of the Invention

The present invention relates to a television receiver (hereinafter, referred to simply as “television”), and more particularly relates to the display of messages.

2. Description of the Related Art

Televisions capable of displaying a given message on the screen are known.

An example of this kind of television is disclosed in Japanese laid-open patent publication 2004-282577. The television comprises: a memory that stores message data for display of messages; a remote control that can be operated for selection of each message and for designation of the time at which the message is displayed; and a controller that, when a time designated for display of a message comes, displays on a display the message associated with the time.

Japanese laid-open patent publication 2003-280625 discloses a television comprising a plurality of input terminals into which video signals are input from video equipment and a controller that determines whether or not video signals are being input into the input terminals. Based on the determination, the controller displays on a display a message to notify a user that video equipment is on when the television is powered off.

Japanese laid-open patent publication Hei 10-276379 discloses a television designed to record a user specified message in a memory so that a controller can call up the message from the memory and display it on a display when the television is powered on.

Japanese laid-open patent publication Hei 9-37176 discloses a television that, in response to a press of a specific key by a user, can read out schedule data for the day from a memory to display a message recorded in the schedule data on a display while outputting to the display video signals of a broadcast program received from a tuner. The television allows a user to check the schedule for the day while viewing the video of a broadcast program. However, this television requires a user to press the specific key before checking the schedule for the day.

Further, Japanese laid-open patent publication Hei 9-23392 discloses a television that, in response to a user operation for power-off of the television, displays on a display a message to notify the user that a received image disappears at the time of the power-off and comes into the off-state after completion of the message display.

None of the inventions described in the above publications 2004-282577 to Hei 9-23392 can ensure the display of a message indicating things to keep in mind on the day so as to call a user's attention to, for example, documents to be carried on the day before the user goes out. Further, the inventions described in the above publications 2004-282577 and Hei 10-276379 do not allow easy deletion of a message having been displayed on a display from a memory.

### SUMMARY OF THE INVENTION

An object of the present invention is to provide a television receiver that can reliably display a message recorded in a recording medium on display means before a user goes out and that can easily delete a message having been displayed on the display means from the recording medium.

According to an aspect of the present invention, this object is achieved by a television receiver comprising: a tuner that receives television signals (hereinafter, referred to as “TV signals”); display means for displaying various messages as well as video based on video signals contained in the TV signals received by the tuner; audio output means for outputting audio based on audio signals contained in the TV signals received by the tuner; operation means having various buttons including a power button for powering on and off the television receiver and an acknowledge button to be used by a user for entry of acknowledgement; a recording medium that stores messages including a message input through the operation means; message determining means for determining whether or not a message is recorded in the recording medium; and control means for controlling each component in the television receiver.

When a user presses the power button to power off the television receiver, the control means determines, by the message determining means, whether or not a message that has yet to be displayed is recorded in the recording medium. When it is determined that there is a yet-to-be-displayed message recorded in the recording medium, the control means causes the display means to display the yet-to-be-displayed message recorded in the recording medium. Subsequently, when a user presses the acknowledge button, the control means deletes the message displayed on the display means from the recording medium.

With the above described configuration, the television receiver enables the display means to display a yet-to-be-displayed message recorded in the recording medium when a user presses the power button to power off the television receiver before going out. This makes it possible to ensure that a message indicating things to keep in mind on the day is displayed to call a user's attention to, for example, documents to be carried on the day before the user goes out. Further, the television receiver can delete a message having been displayed on the display means from the recording medium in response to a press of the acknowledge button by a user. This enables a message to be easily deleted from the recording means after displayed on the display means and can prevent shortage of the available space in the recording medium.

Preferably, the television receiver further comprises: a network interface to be connected to the Internet via a cable; and e-mail receiving means for receiving an e-mail via the network interface, wherein the messages to be recorded in the recording medium include a message received by the e-mail receiving means.

Further preferably, the television receiver further comprises alarm control means for causing the audio output means to output an alarm, wherein when a user presses the power button to power off the television receiver, the control means determines, by the message determining means, whether or not a message that has yet to be displayed is recorded in the recording medium, wherein when it is determined that there is a yet-to-be-displayed message recorded in the recording medium, the control means not only causes the display means to display the yet-to-be-displayed message recorded in the recording medium but also causes the audio output means to sound an alarm by the alarm control means.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an external view of a television receiver according to an embodiment of the present invention, a remote control to be used for controlling the television receiver, and a mobile phone connected to the television receiver via the Internet;

FIG. 2 is a block diagram showing the internal configuration of the television receiver; and

FIG. 3 is a flowchart showing the steps of a process to be executed when the television receiver is powered off.

### DESCRIPTION OF THE PREFERRED EMBODIMENTS

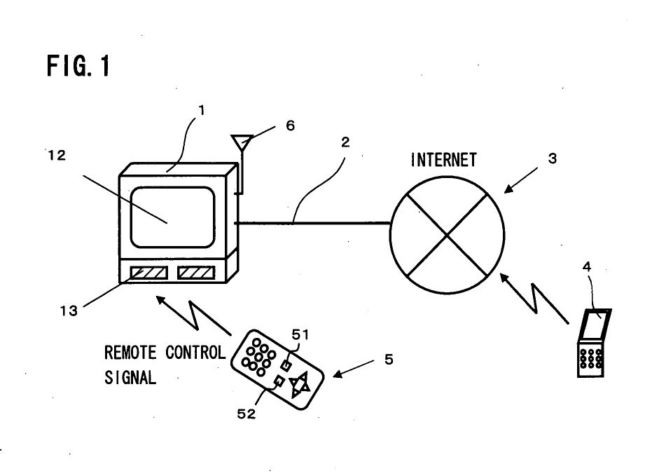

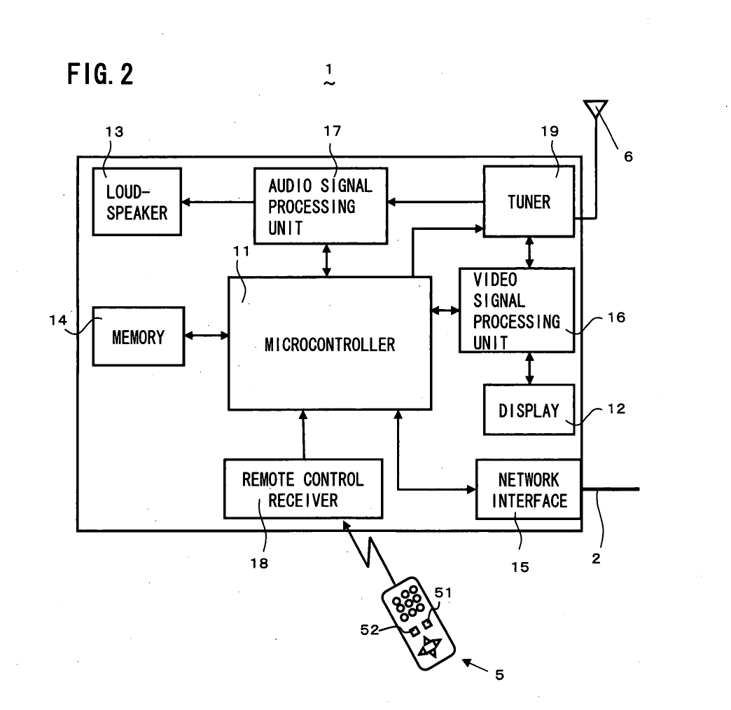

Referring now to FIG. 1 and FIG. 2, an embodiment of the present invention is described. It is to be noted that the following description of preferred embodiment of the present invention has been presented for purposes of illustration and description, and is not intended to be exhaustive or to limit the present invention to the precise form disclosed.

FIG. 1 shows a system comprising: a television receiver 1 (hereinafter, referred to simply as “television”) connected to the Internet 3 via a network cable 2 (cable); a remote control 5 (operation means) to be used for operations of the television 1; and a mobile phone 4 capable of sending an e-mail to the television 1 via the Internet 3. FIG. 2 shows the internal configuration of the television 1.

The television 1 comprises: a tuner 19 that receives television signals (hereinafter, referred to as “TV signals”) through an antenna 6; a network interface 15 to be connected to the Internet 3 via the network cable 2; a video signal processing unit 16 that processes video signals contained in TV signals received by the tuner 19 in a predetermined manner; a display 12 that displays various messages as well as video based on video signals received from the video signal processing unit 16; an audio signal processing unit 17 that processes audio signals contained in TV signals received by the tuner 19 in a predetermined manner; a loudspeaker 13 (audio output means) that outputs audio based on audio signals received from the audio signal processing unit 17; and a microcontroller 11 (control means) that controls each component in the television.

The television 1 further comprises: a remote control receiver 18 that receives signals transmitted from the remote control 5 for output to the microcontroller 11; and a memory 14 (recording medium) that stores, for example, a message input by operating the remote control 5.

The microcontroller 11 serves as: e-mail receiving means for receiving an e-mail via the network interface 15; message determining means for determining whether or not there is a message recorded in the memory 14; and alarm control means for causing an alarm to be sounded from the loudspeaker 13. The microcontroller 11 can record a received e-mail message in the memory 14.

The remote control 5 has a power button 51 to power on and off the television 1, an enter button 52 (acknowledge button in claims) to be used by a user for acknowledgement of a process executed by the microcontroller 11, and so on.

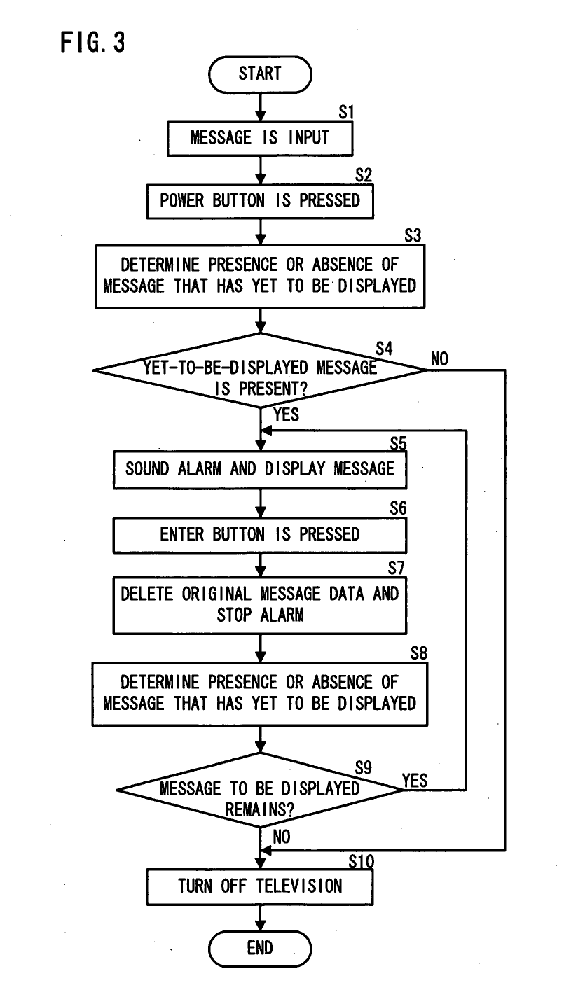

Referring now to FIG. 3, it is described what process is executed when the television 1 according to this embodiment is powered off. When the mobile phone 4, a personal computer not shown, or the like sends an e-mail to the television 1 via the Internet 3, the microcontroller 11 receives the sent e-mail and records a message contained in the received e-mail in the memory 14 (S1). As well, the microcontroller 11 records a message input by a user through the remote control 5 in the memory 14. Then, when a user powers off the television 1 by operating the power button 51 on the remote control 5 (S2), the microcontroller 11 determines whether or not a message that has yet to be displayed is recorded in the memory 14 (S3). If it is determined that there is no yet-to-be-displayed message recorded in the memory 14 (NO at S4), the microcontroller 11 turns off the television 1 (S10), and exits the process.

On the other hand, if it is determined at the step S3 that there is a yet-to-be-displayed message recorded in the memory 14 (YES at S4), the microcontroller 11 causes an alarm to be sounded from the loudspeaker 13 and causes the yet-to-be-displayed message recorded in the memory 14 to be displayed on the display 12 (S5). When a user presses the enter button 52 on the remote control 5 (S6), the microcontroller 11 stops the alarm and deletes the message having been displayed on the display 12 from the memory 14 (S7). Subsequently, the microcontroller 11 determines whether or not a message yet to be displayed remains in the memory 14 (S8). If no message to be displayed remains in the memory 14 (YES at S9), the microcontroller 11 turns off the television 1 (S10), and exits the process.

If it is determined at the step S8 that there is a yet-to-be-displayed message in the memory 14 (NO at S9), the microcontroller 11 repeats the above described process of the steps S5 to S8.

As described above, the television 1 according to this embodiment enables the display 12 to display a yet-to-be-displayed message recorded in the memory 14 when a user presses the power button 51 on the remote control 5 to power off the television 1 before going out. This makes it possible to ensure that a message indicating things to keep in mind on the day is displayed to call a user's attention to, for example, documents to be carried on the day before the user goes out. Further, the television 1 can delete a message having been displayed on the display 12 from the memory 14 when a user presses the enter button 52 on the remote control 5. This enables a message to be easily deleted from the memory 14 after displayed on the display 12 and can prevent shortage of the available space in the memory 14.

The microcontroller 11 serves as the e-mail receiving means for receiving an e-mail via the network interface 15 and can record a message in an e-mail received thereby in the memory 14. This enables a user to record a message in the memory 14 through e-mail, thus enhancing convenience for users.

When there is a yet-to-be-displayed message recorded in the memory 14, the microcontroller 11 causes the loudspeaker 13 to sound an alarm and causes the display 12 to display the yet-to-be-displayed message recorded in the memory 14. In this manner, since an alarm is sounded from the loudspeaker 13 in addition to the display of a message on the display 12, a user is less likely to miss the message displayed on the display 12.

The present invention has been described above using a presently preferred embodiment, but those skilled in the art will appreciate that various modifications are possible. For example, in the above described embodiment, not only an e-mail message sent from the mobile phone 4 and a personal computer, but also a message input through the remote control 5 can be recorded in the memory 14. Alternatively, the present invention can be applied to a television receiver designed to record only a message input through the remote control 5 in the memory 14.

This application is. based on Japanese patent application 2006-41505 filed Feb. 17, 2006, the contents of which are hereby incorporated by reference.

What is claimed is:

1. A television receiver comprising:
a tuner that receives television signals (hereinafter, referred to as “TV signals”);
display means for displaying various messages as well as video based on video signals contained in the TV signals received by the tuner;
audio output means for outputting audio based on audio signals contained in the TV signals received by the tuner;
operation means having various buttons including a power button for powering on and off the television receiver and an acknowledge button to be used by a user for entry of acknowledgement;
a recording medium that stores messages including a message input through the operation means;
message determining means for determining whether or not a message is recorded in the recording medium; and
control means for controlling each component in the television receiver,
wherein when a user presses the power button to power off the television receiver, the control means determines, by the message determining means, whether or not a message that has yet to be displayed is recorded in the recording medium,
wherein when it is determined that there is a yet-to-be-displayed message recorded in the recording medium, the control means causes the display means to display the yet-to-be-displayed message recorded in the recording medium, and subsequently, when a user presses the acknowledge button, the control means deletes the message displayed on the display means from the recording medium.

2. The television receiver according to claim 1, further comprising:
a network interface to be connected to the Internet via a cable; and
e-mail receiving means for receiving an e-mail via the network interface,
wherein the messages to be recorded in the recording medium include a message received by the e-mail receiving means.

3. The television receiver according to claim 2, further comprising alarm control means for causing the audio output means to output an alarm,
wherein when a user presses the power button to power off the television receiver, the control means determines, by the message determining means, whether or not a message that has yet to be displayed is recorded in the recording medium,
wherein when it is determined that there is a yet-to-be-displayed message recorded in the recording medium, the control means not only causes the display means to display the yet-to-be-displayed message recorded in the recording medium but also causes the audio output means to sound an alarm by the alarm control means.

4. The television receiver according to claim 1, further comprising alarm control means for causing the audio output means to output an alarm,
wherein when a user presses the power button to power off the television receiver, the. control means determines, by the message determining means, whether or not a message that has yet to be displayed is recorded in the recording medium,
wherein when it is determined that there is a yet-to-be-displayed message recorded in the recording medium, the control means not only causes the display means to display the yet-to-be-displayed message recorded in the recording medium but also causes the audio output means to sound an alarm by the alarm control means.
